(19) United States
(12) Patent Application Publication
(10) Pub. No.: US 2007/0192629 A1
(43) Pub. Date: Aug. 16, 2007

(54) Storage system, encryption path switching system, encryption path switching program, and recording medium thereof

(75) Inventor: Kinya Saito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/336,939

(22) Filed: Jan. 23, 2006

(30) Foreign Application Priority Data
Oct. 3, 2005 (JP) 2005-289478

(51) Int. Cl. H04L 9/32; H04L 9/00; G06F 12/14; G06K 9/00; G06F 17/30; G06F 11/30; G06F 7/04

(52) U.S. Cl. 713/193; 726/2; 713/153

(57) ABSTRACT

In a storage system, a server, a storage device, and an encryption device are connected to ports of a fabric switch. Encryption management software of the server performs, on the basis of encryption setting information inputted to an encryption setting information storing unit from the outside and stored in the encryption setting information storing unit, connection setting for the ports of the fabric switch such that a path from the server to the storage on which encryption is performed passes through the encryption device and such that a path on which encryption is not performed does not pass through the encryption device. It is possible to freely switch a path on which encryption is performed simply by changing encryption setting information.

### CROSS-REFERENCE TO RELATED APPLICATIONS

This application claims the conventional priority based on Japanese Patent Application No. 2005-289478, filed on Oct. 3, 2005, the disclosures of which are incorporated herein by reference.

### BACKGROUND OF THE INVENTION

1. Field of the Invention

This invention generally relates to a storage system, and more especially to a storage system, an encryption path switching method, an encryption path switching program and a recording medium thereof, which are capable of freely setting a path passing through an encryption device and a path not passing through the encryption device by switching a path of a fabric switch.

2. Description of the Related Art

FIG. 10 is a diagram showing an example of a conventional storage system. The example in FIG. 10 is an example of a storage system in which an encryption device 300 is arranged between interface which connects a server 100 and a storage device 200. The encryption device 300 is a device which encrypts data to be written in the storage device 200 and decrypts data read out from the storage device 200.

Conventionally, as the storage system using the encryption device 300, there is a storage system in which the encryption device 300 is arranged between a specific interface card of the server 100 and a specific drive of the storage device 200. In this storage system, a path for encryption is fixed to a path on which the encryption device 300 is arranged. Thus, it is impossible to perform encryption of data on other paths.

In the example in FIG. 10, since the encryption device 300 is arranged between the server 100 and a drive D of the storage device 200, it is possible to encrypt data to be written in the drive D through the encryption device 300. However, since data to be written in a drive B does not pass through the encryption device 300, it is impossible to encrypt the data.

As related art documents in which a technique for encrypting data to be transmitted to the storage device 200 is described, there is Japanese Patent Application Laid-open No. 2002-312223 and the like. Japanese Patent Application Laid-open No. 2002-312223 describes a technique for transmitting data from a local disk system to a remote disk system. In this technique, it is possible to select, on an encryption control table, whether data should be encrypted. However, this technique described in Japanese Patent Application Laid-open No. 2002-312223 is a technique for transparently exchanging an encryption key between the local disk system and the remote disk system to control encryption of data in a storage. Thus, this technique is not a technique for controlling a path passing through the encryption device 300 arranged between the server 100 and the storage device 200.

We studied two ideas shown in FIGS. 11A and 11B, for example, as a method of making it possible to encrypt and decrypt data inputted to and outputted from arbitrary drives A to D in the storage system having the server 100 and the storage device 200 shown in FIG. 10. FIGS. 11A and 11B are diagrams showing example of a storage system for explaining problems to be solved by the present invention.

A first idea is, as shown in FIG. 11A, a method of inserting encryption devices 300-1 to 300-4 on paths between the server 100 and the respective drives A to D, respectively. According to this method, it is possible to encrypt data to be written in any one of the drives A to D. However, since encryption devices as many as the number of drives are required, cost for the storage system increases. Further, since data not to be encrypted also necessarily passes through the encryption devices, performance of input and output of data is deteriorated.

On the other hand, a second idea is, as shown in FIG. 11B, a method of using a fabric switch 400 in order to use one encryption device 300 on a plurality of paths. According to this method, since only one encryption device 300 is required, the problem of the increase in cost is solved. However, since the all paths to the drives A to D of the storage device 200 still pass through the encryption device 300, performance of input and output is deteriorated. Like the storage system in FIG. 11A, the storage system in FIG. 11B is also capable of recording encrypted data in any one of the drives A to D of the storage device 200. However, since data not to be encrypted also passes through the encryption device 300, performance of input and output is deteriorated.

For example, data to be written in the drive D is required to be sent through the encryption device 300 because the data is encrypted. However, even when data to be written in the drive B is not encrypted, the path to the drive B also passes through the encryption device 300, resulting in deterioration in performance.

### SUMMARY OF THE INVENTION

It is an object of the present invention to solve the above problems, and to make it possible to easily change a path on which encryption is performed and a path on which encryption is not performed, thereby it becomes possible to switch and use an encryption path and to realize prevention of deterioration in performance, in a storage system.

It is another object of the present invention to provide a storage system which makes it possible to easily change a path on which encryption is performed and a path on which encryption is not performed.

It is further object of the present invention to provide a encryption path switching method which makes it possible to easily change a path on which encryption is performed and a path on which encryption is not performed.

It is still further object of the present invention to provide a encryption path switching program which makes it possible to easily change a path on which encryption is performed and a path on which encryption is not performed.

It is still further object of the present invention to provide a computer readable recording medium recording an encryption path switching which makes it possible to easily change a path on which encryption is performed and a path on which encryption is not performed.

In order to solve the above problems, the present invention sets a path by a switch device such as a fabric switch so as to pass through an encryption device when data is encrypted, and sets a path by the switch device so as not to pass through the encryption device when data is not encrypted.

Specifically, a storage system of the present invention comprises at least a storage device which stores data, at least a server which writes data in and reads out data from the storage device, an encryption device which encrypts data to be written in the storage device by the server and decrypts data to be read out from the storage device by the server, and a switch device which has a plurality of ports to which at least a server, a storage device, and the encryption device are connected, and switches a plurality of paths connecting the plurality of ports according to setting from the outside of the switch device. The server further comprises means for inputting encryption setting information each of which designates a server resource corresponding to an element of the storage device to be encrypted, means for storing the inputted encryption setting information, and means for setting connection between the plurality of ports of the switch device on a basis of the stored encryption setting information such that a path on which encryption is performed passes through the encryption device and a path on which encryption is not performed does not pass through the encryption device.

An encryption path switching method of the present invention is executed in a storage system. The storage system comprises at least a storage device which stores data, at least a server which writes data in and reads out data from the storage device, an encryption device which encrypts data to be written in the storage device by the server and decrypts data to be read out from the storage device by the server, and a switch device which has a plurality of ports to which at least a server, a storage device, and the encryption device are connected, and switches a plurality of paths connecting the plurality of ports according to setting from the outside of the switch device. The method comprises the server inputting encryption setting information each of which designates a server resource corresponding to an element of the storage device to be encrypted, the server storing the inputted encryption setting information, and the server setting connection between the plurality of ports of the switch device on a basis of the stored encryption setting information such that a path on which encryption is performed passes through the encryption device and a path on which encryption is not performed does not pass through the encryption device.

An encryption path switching program of the present invention is executed by a computer of a server in a storage system. The storage system comprises at least a storage device which stores data, at least a server which writes data in and reads out data from the storage device, an encryption device which encrypts data to be written in the storage device by the server and decrypts data to be read out from the storage device by the server, and a switch device which has a plurality of ports to which at least a server, a storage device, and the encryption device are connected, and switches a plurality of paths connecting the plurality of ports according to setting from the outside of the switch device. The program causes the computer to execute inputting encryption setting information each of which designates a server resource corresponding to an element of the storage device to be encrypted, storing the inputted encryption setting information, and setting connection between the plurality of ports of the switch device on a basis of the stored encryption setting information such that a path on which encryption is performed passes through the encryption device and a path on which encryption is not performed does not pass through the encryption device.

A computer readable recording medium of the present invention records an encryption path switching program executed by a computer of a server in a storage system. The storage system comprises at least a storage device which stores data, at least a server which writes data in and reads out data from the storage device, an encryption device which encrypts data to be written in the storage device by the server and decrypts data to be read out from the storage device by the server, and a switch device which has a plurality of ports to which at least a server, a storage device, and the encryption device are connected, and switches a plurality of paths connecting the plurality of ports according to setting from the outside of the switch device. The program causes the computer to execute inputting encryption setting information each of which designates a server resource corresponding to an element of the storage device to be encrypted, storing the inputted encryption setting information, and setting connection between the plurality of ports of the switch device on a basis of the stored encryption setting information such that a path on which encryption is performed passes through the encryption device and a path on which encryption is not performed does not pass through the encryption device.

### BRIEF DESCRIPTION OF THE DRAWINGS

FIG. 1 is a diagram showing an example of a storage system according to an embodiment of the present invention.

FIG. 2 is a diagram showing an example of a structure of an encryption device.

FIG. 3 is a diagram showing an example of a structure of encryption management software according to the embodiment.

FIGS. 4A and 4B are tables for encryption setting information and fabric setting management, respectively.

FIG. 5 is a diagram showing an example of an encryption setting screen.

FIG. 6 is a flowchart of encryption path switching processing by the encryption management software.

FIGS. 7A and 7B are diagrams for explaining an example in which a drive D is set as a drive in which data is written in encryption.

FIGS. 8A and 8B are diagrams for explaining an example in which drives C and D are set as drives in which data is written in encryption.

FIGS. 9A and 9B are diagrams for explaining switching of a path passing through the encryption device.

FIG. 10 is a diagram showing an example of a conventional storage system.

FIGS. 11A and 11B are diagrams showing examples of a storage system for explaining problems to be solved by the present invention.

### DETAILED DESCRIPTION OF THE PREFERRED EMBODIMENT

An embodiment of the present invention will be explained hereinafter with reference to the accompanying drawings.

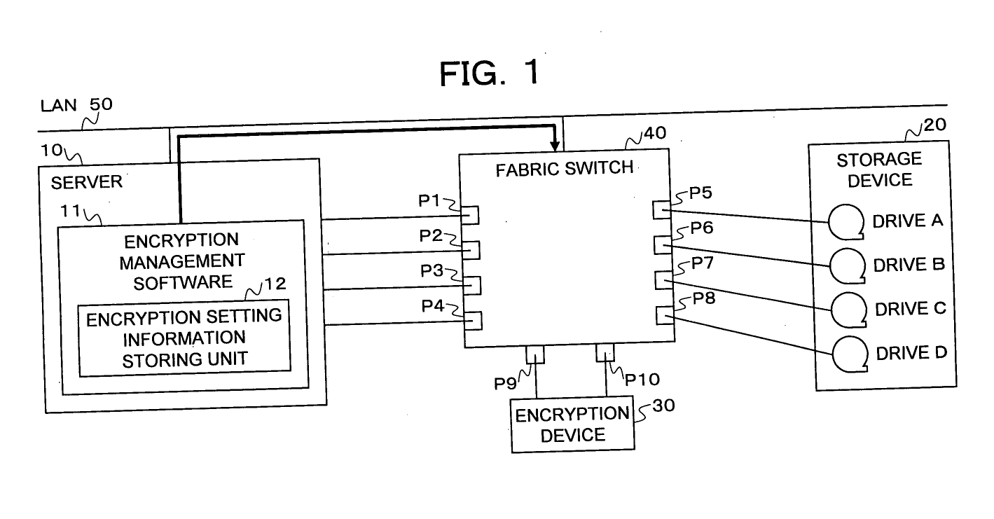

FIG. 1 is a diagram showing an example of a storage system according to an embodiment of the present invention. In the storage system, a fabric switch 40 is arranged between a server 10 and a storage device 20. The server 10 and the fabric switch 40 are connected via a LAN 50.

The server 10 in this embodiment is a processing apparatus having a CPU and a memory. The server 10 accesses the storage device 20 through paths via the fabric switch 40 and writes data in and reads out data from the storage device 20. In the writing and reading of data, encryption and decryption may be performed by the encryption device 30 at the time of writing and at the time of reading, respectively, according to setting of encryption.

The fabric switch 40 is a switch device which switches a path connecting the server 10, the storage device 20, and the encryption device 30. The fabric switch 40 comprises, for example, one fiber channel switch. The fabric switch 40 may comprise a plurality of switches.

The storage device 20 is a library device having four drives (elements) A to D. The drives A to D are connected to ports P5 to P8 of the fabric switch 40, respectively. The server 10 is connected to ports P1 to P4 of the fabric switch 40 by an interface for transmitting data to the respective drives of the storage device 20. The server 10 and the fabric switch 40 are also connected via the LAN 50, in addition to the interface through which the server 10 and the fabric switch 40 are directly connected. The encryption device 30 is connected to ports P9 and P10 of the fabric switch 40.

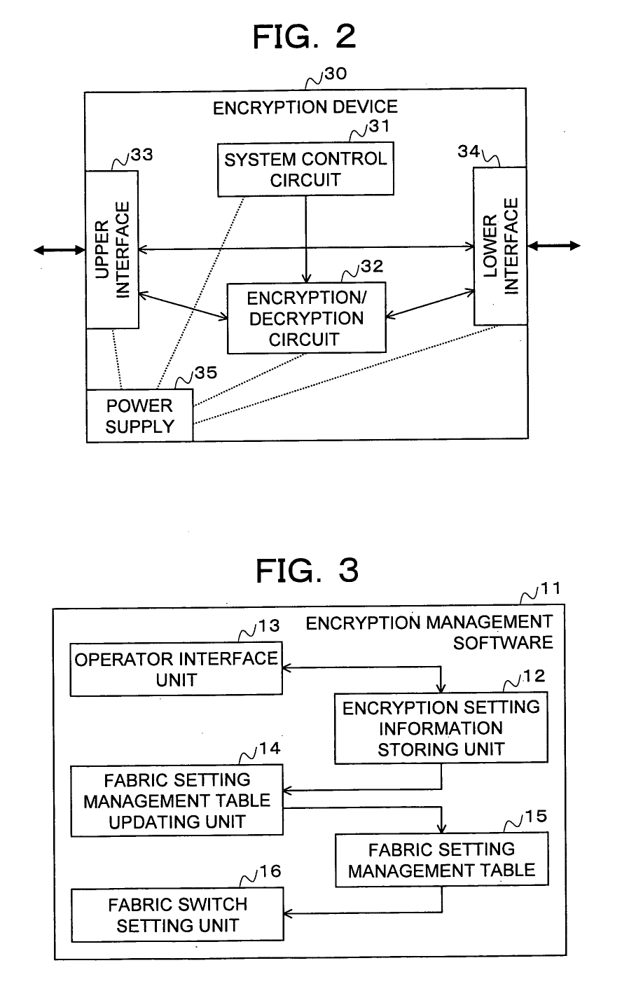

FIG. 2 is a diagram showing an example of a structure of an encryption device 30. The encryption device 30 comprises a system control circuit 31, an encryption/decryption circuit 32, a upper interface 33, a lower interface 34, and a power supply 35.

The system control circuit 31 controls the entire encryption device 30 by its CPU or the like. The encryption/decryption circuit 32 encrypts data sent from the server 10 to the storage device 20, and decrypts data sent from the storage device 20 to the server 10. The upper interface 33 is a connection interface circuit on the server 10 side (or the server end). The lower interface 34 is a connection interface circuit on the storage device 20 side (or the device end). The power supply 35 supplies power to the respective circuits. The encryption device 30 of this type is a device often used conventionally and well known. Therefore, further explanations of the encryption device 30 are omitted.

An encryption management software program (hereinafter referred to as an encryption management software) 11 is installed in the server 10. The encryption management software 11 logs in the fabric switch 40 through the LAN 50, and performs setting for paths by the fabric switch 40 according to encryption setting information stored in an encryption setting information storing unit 12. That is, the encryption management software 11 controls the fabric switch 40 to perform setting for such port connection that a path on which encryption is performed passes through the encryption device 30, and such port connection that a path on which encryption is not performed does not pass through the encryption device 30.

FIG. 3 is a diagram showing an example of a structure of the encryption management software 11 in the embodiment. The encryption management software 11 comprises an operator interface unit 13, an encryption setting information storing unit 12, a fabric setting management table updating unit 14, a fabric setting management table 15, and a fabric switch setting unit 16.

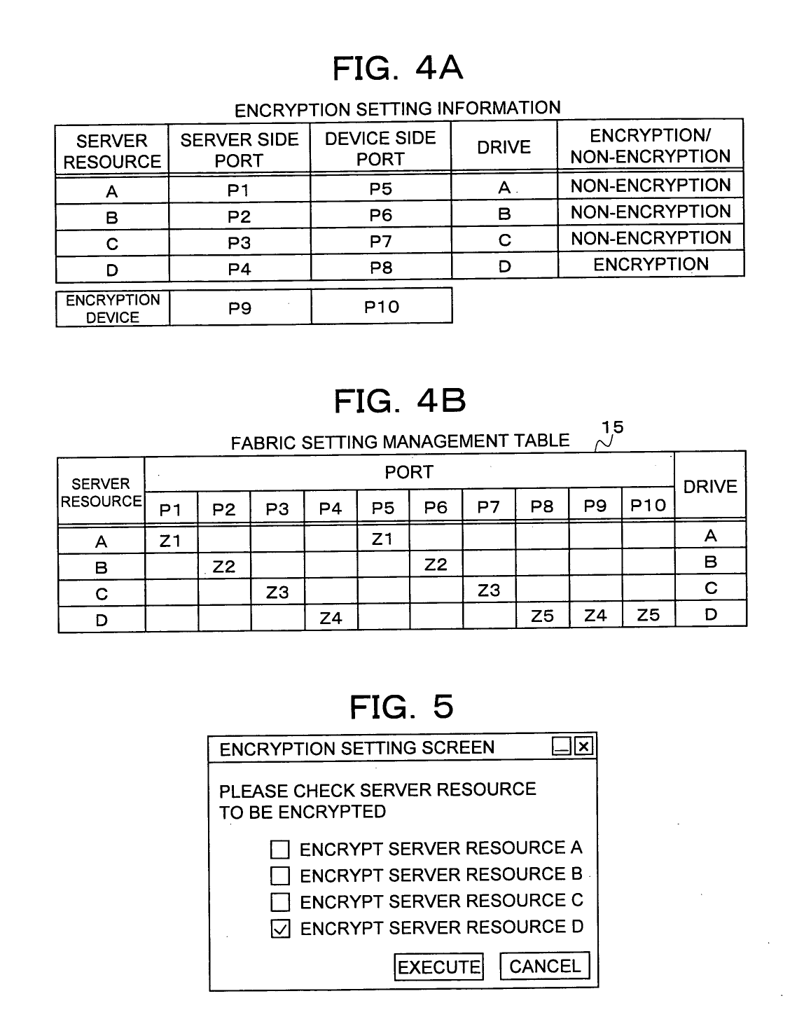

The encryption setting information storing unit 12 stores information for setting whether respective server resources should be encrypted or not. In this embodiment, resources such devices which is used by software programs operating on the server 10 are referred to as server resources. FIG. 4A shows an example of the encryption setting information stored in the encryption setting information storing unit 12. The encryption setting information storing unit 12 stores relation information between the server resources and the drives of the storage device 20, and information indicating whether the relation information should be encrypted or not. In addition, the encryption setting information storing unit 12 stores information on ports to which the respective server resources, the drives, and the encryption device are connected.

The fabric setting management table 15 stores information for setting port connection in the fabric switch 40. FIG. 4B shows an example of a fabric setting management table. The fabric setting management table 15 records information indicating which ports are connected with each other when the respective server resources

A to D and the respective drives A to D are connected by paths. Ports to which the same sign (Zi) is assigned in the fabric setting management table 15 are connected with each other. For example, in setting for a path connecting the server resource A and the drive A, since the same sign (Z1) is assigned to the port P1 and the port P5, the port P1 and the port P5 are connected.

When a setting request for a server resource to be encrypted is received from an operator, the operator interface unit 13 displays an encryption setting screen on a display, receives an input of an encryption setting instruction from the operator via the encryption setting screen, and stores encryption setting information in the encryption setting information storing unit 12. The fabric setting management table updating unit 14 updates the fabric setting management table 15 according to the encryption setting information stored in the encryption setting information storing unit 12. The fabric switch setting unit 16 performs connection setting for the respective ports P1 to P10 of the fabric switch 40 according to contents of the fabric setting management table 15.

FIG. 5 is a diagram showing an example of the encryption setting screen. When the operator activates the encryption management software 11, the operator interface unit 13 displays an encryption setting screen shown in FIG. 5. Then, when a server resource to be encrypted is designated on the encryption setting screen and the execution button is clicked by the operator, encryption setting information is stored in the encryption setting information storing unit 12 according to the designation. The fabric setting management table updating unit 14 updates the fabric setting management table 15 according to the encryption setting information. For example, the server resource D is an object of encryption in the encryption setting information shown in FIG. 4A. Then, the fabric setting management table updating unit 14 updates the fabric setting management table 15 such that the port P4 and the port P9 of the fabric switch 40 are connected, and such that the port P8 and the port P10 of the fabric switch 40 are connected. The fabric switch setting unit 16 performs setting for the fabric switch 40 according to the updated fabric setting management table 15. When the setting ends, indication of completion of the setting is displayed on a setting completion notice screen (not shown) and the completion of the setting is notified to the operator.

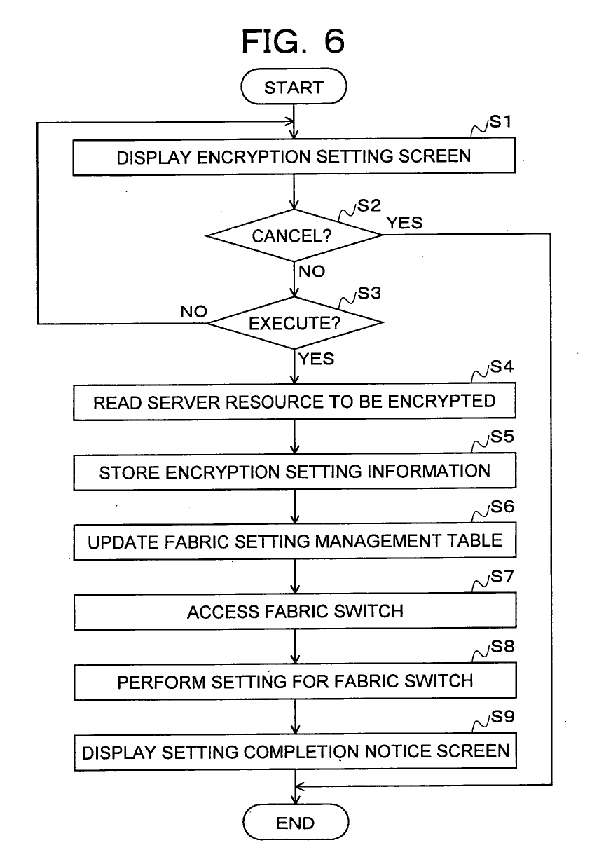

FIG. 6 is a flowchart of encryption path switching processing which is executed by the encryption management software 11. First, the encryption management software 11 displays the encryption setting screen shown in FIG. 5 (step S1). When the operator clicks a cancel button, the encryption management software 11 ends the processing without doing anything (step S2). When the operator designates a server resource to be encrypted on the encryption setting screen and clicks the execution button (step S3), the encryption management software 11 reads encryption setting information of the server resource to be encrypted (step S4), and stores the encryption setting information in the encryption setting information storing unit 12 (step S5).

The fabric setting management table updating unit 14 updates the fabric setting management table 15 according to the encryption setting information (step S6). Due to the updating the fabric setting management table 15, the fabric switch setting unit 16 accesses the fabric switch 40 via the LAN 50 (step S7), and performs setting for the fabric switch 40 according to the fabric setting management table 15 (step S8). When the setting ends, the fabric switch setting unit 16 displays the setting completion notice screen to notify the operator of completion of the setting (step S9), and ends the processing.

In the following description, the embodiment of the present invention will be explained with reference to a more specific example.

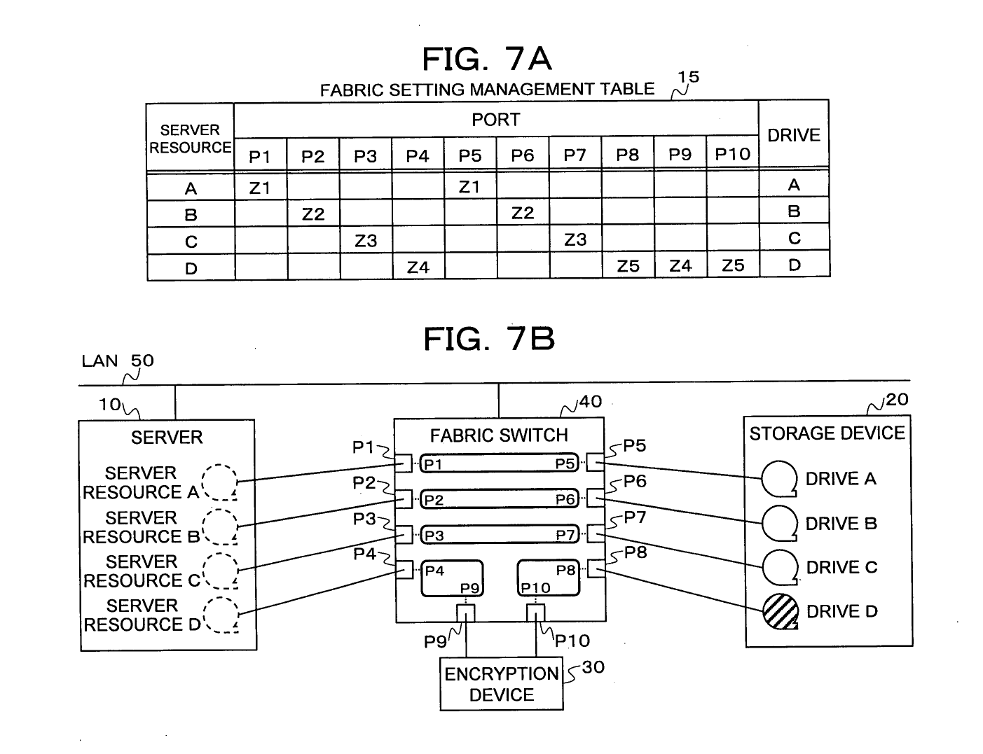

FIGS. 7A and 7B are diagrams for explaining an example in which the drive D is set as a drive to which data is written in encryption. FIG. 7A is the fabric setting management table 15 in a case that encryption is performed on a path to the drive D.

FIG. 7B is a diagram of a connection state among ports in the above case. In FIG. 7B, hatching is applied to the drive D to which data is written after being encrypted. In this example, encryption is not performed on a path from the server resource A to the drive A, a path from the server resource B to the drive B, and a path from the server resource C to the drive C, and encryption is performed on a path from the server resource D to the drive D.

The path from the server resource A to the drive A, the path from the server resource B to the drive B, and the path from the server resource C to the drive C do not need to pass through the encryption device 30. Thus, the port P1 and the port P5, the port P2 and the port P6, and the port P3 and the port P7 are connected, respectively. The path from the server resource D to the drive D needs to pass through the encryption device 30. Thus, the port P4 and the port P9 are connected, and the port P10 and the port P8 are connected, respectively.

In a case explained below, the setting is changed from the state described above to set the drive C as a drive to be used in encryption as well.

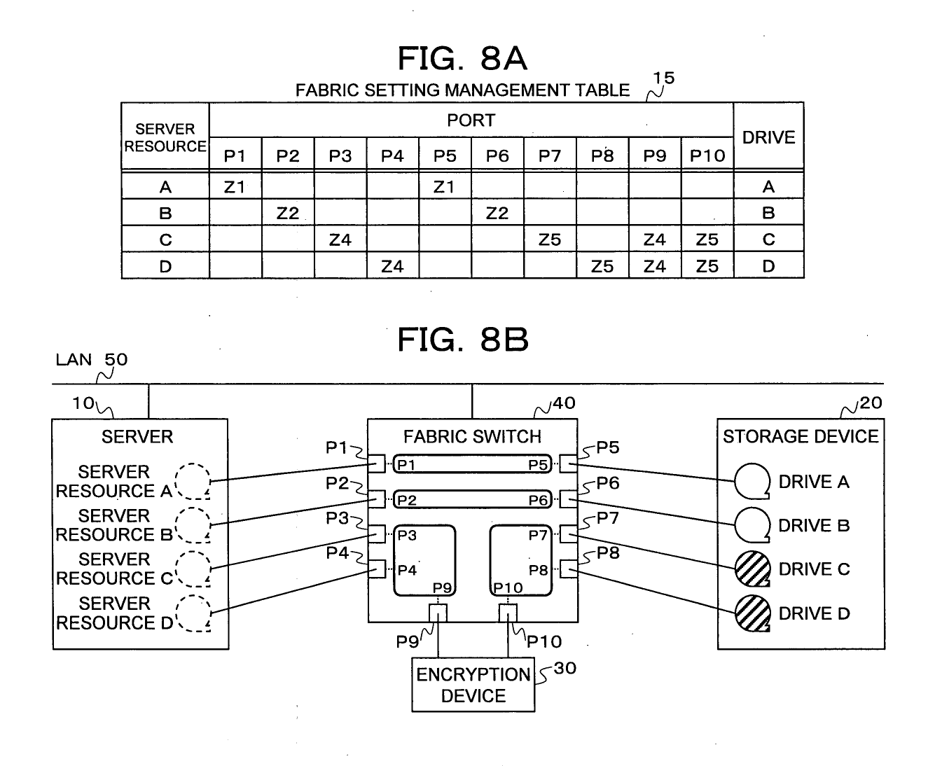

FIGS. 8A and 8B are diagrams for explaining an example in which the drive C and the drive D are set as drives to which data is written in encryption. FIG. 8A is the fabric setting management table 15 in a case that paths to the drive C and the drive D are encrypted. FIG. 8B is a diagram of a connection state among ports in the above case. In FIG. 8B, hatching is applied to the drive C and the drive D to which data is written after being encrypted.

In the fabric setting management table 15 in FIG. 7A, in order to set the drive C as a drive to be used in encryption, setting for the path from the server resource C to the drive C is changed. As shown in FIG. 8A, connection between the port P3 and the port P9 and connection between the port P10 and the port P7 are set such that the path from the server resource C to the drive C passes through the encryption device 30.

A connection state among ports is shown in FIG. 8B. In the path from the server resource A to the drive A, the port P1 and the port P5 are connected. In the path from the server resource B to the drive B, the port P2 and the port P6 are connected. In the path from the server resource C to the drive C, the port P3 and the port P9 are connected and the port P10 and the port P7 are connected. In the path from the server resource D to the drive D, the port P4 and the port P9 are connected and the port P10 and the port P8 are connected.

As in the example in FIG. 8B, when a plurality of paths pass through the encryption device 30, data outputted from the encryption device 30 needs to be switched (or assigned). For example, in FIG. 8B, data outputted from the port P10 has to be switched to the port P7 or the port P8. In the following description, an example of switching of the paths (or data) passing through the encryption device 30 will be explained.

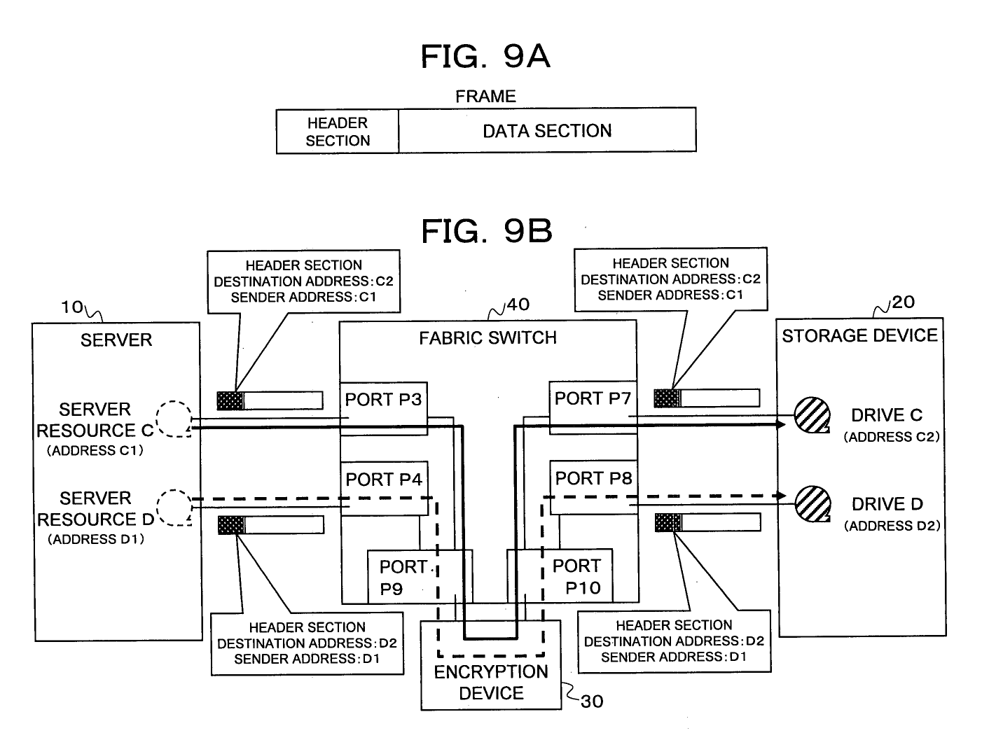

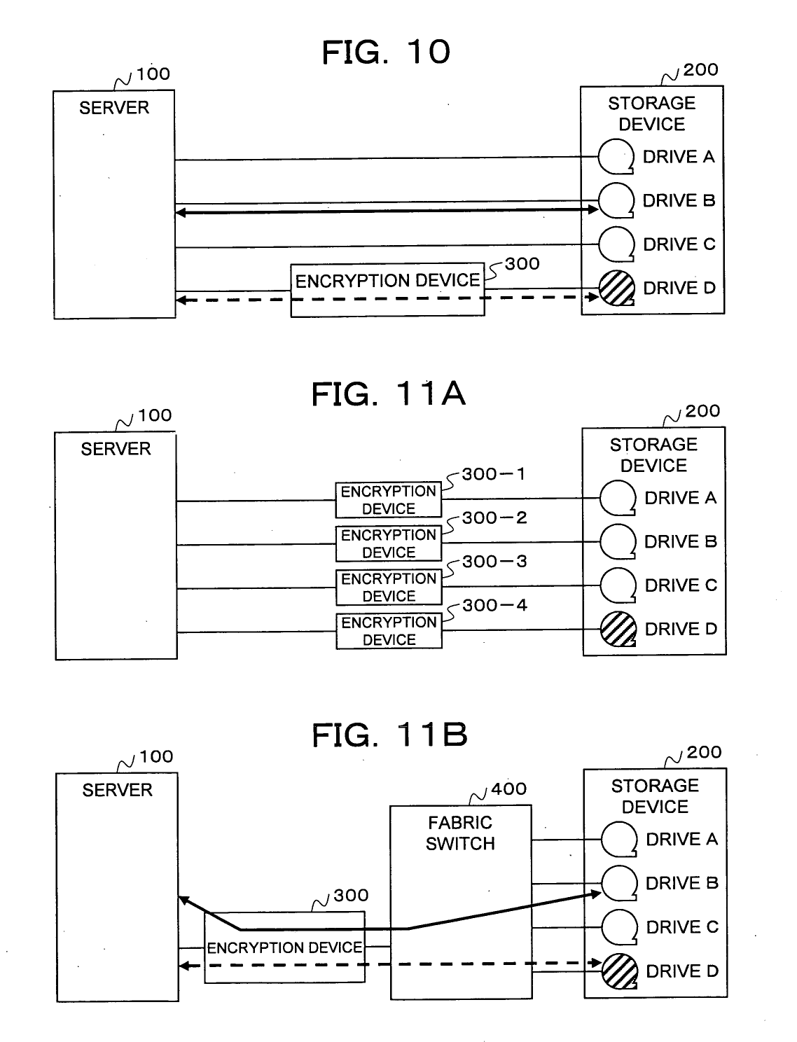

FIGS. 9A and 9B are diagrams for explaining switching of paths passing through the encryption device 30. A frame passing through the fabric switch 40 basically comprises, for example, as shown in FIG. 9A, a header section and a data section. The header section of the frame stores a destination address, a sender address, and exchange IDs, etc. The data section of the frame stores commands, and data, etc. for the devices. Switching of paths through which the frame is fed is performed with reference to the destination address stored in the header section of the frame, etc.

As shown in FIG. 9B, it is assumed that an address of an access requesting source of the server resource C is C1, an address of the drive C is C2, an address of an access requesting source of the server resource D is D1, and an address of the drive D is D2. In this case, C2 is recorded as a destination address and C1 is recorded as a sender address in a header section of a frame transmitted from the server resource C to the drive C. D2 is recorded as a destination address and D1 is recorded as a sender address in a header section of a frame transmitted from the server resource D to the drive D.

In a part where paths are branched, switching of the paths is performed on the basis of the destination addresses recorded in the header sections. For example, at the port P10 shown in FIG. 9B, the frame having the destination address C2 recorded in the header section is switched to the port P7, and the frame having the destination address D2 recorded in the header section is switched to the port P8.

It is possible to realize the setting processing for encryption path switching executed by the server 10 in the embodiment explained above by using a computer and a software program. It is possible to record the program in a computer readable recording medium, and to provide the program through a network.

As explained above in the embodiment, in the present invention, by controlling connection among the ports of the fabric switch 40, it is possible to switch and use, as required, a drive to which data is written after being encrypted and a drive to which data is written without being encrypted.

The present invention is not limited to the embodiment explained above. For example, in the above embodiment, the storage system comprises the one server 10, the one storage device 20, the one encryption device 30, and the one fabric switch 40. However, the storage system may actually comprise a plurality of servers 10, a plurality of storage devices 20, a plurality of encryption devices 30, and/or a plurality of fabric switches 40.

What is claimed is:

1. A storage system comprising:
at least a storage device which stores data;
at least a server which writes data in and reads out data from the storage device;
an encryption device which encrypts data to be written in the storage device by the server and decrypts data to be read out from the storage device by the server; and
a switch device which has a plurality of ports to which at least a server, a storage device, and the encryption device are connected, and switches a plurality of paths connecting the plurality of ports according to setting from the outside of the switch device,
wherein the server further comprises:
means for inputting encryption setting information each of which designates a server resource corresponding to an element of the storage device to be encrypted;
means for storing the inputted encryption setting information; and
means for setting connection between the plurality of ports of the switch device on a basis of the stored encryption setting information such that a path on which encryption is performed passes through the encryption device and a path on which encryption is not performed does not pass through the encryption device.

2. An encryption path switching method in a storage system which comprises: at least a storage device which stores data; at least a server which writes data in and reads out data from the storage device; an encryption device which encrypts data to be written in the storage device by the server and decrypts data to be read out from the storage device by the server; and a switch device which has a plurality of ports to which at least a server, a storage device, and the encryption device are connected, and switches a plurality of paths connecting the plurality of ports according to setting from the outside of the switch device, the method comprising:
the server inputting encryption setting information each of which designates a server resource corresponding to an element of the storage device to be encrypted;
the server storing the inputted encryption setting information; and
the server setting connection between the plurality of ports of the switch device on a basis of the stored encryption setting information such that a path on which encryption is performed passes through the encryption device and a path on which encryption is not performed does not pass through the encryption device.

3. An encryption path switching program executed by a computer of a server in a storage system which comprises: at least a storage device which stores data; at least a server which writes data in and reads out data from the storage device; an encryption device which encrypts data to be written in the storage device by the server and decrypts data to be read out from the storage device by the server; and a switch device which has a plurality of ports to which at least a server, a storage device, and the encryption device are connected, and switches a plurality of paths connecting the plurality of ports according to setting from the outside of the switch device, the program causing the computer to execute:
inputting encryption setting information each of which designates a server resource corresponding to an element of the storage device to be encrypted;
storing the inputted encryption setting information; and
setting connection between the plurality of ports of the switch device on a basis of the stored encryption setting information such that a path on which encryption is performed passes through the encryption device and a path on which encryption is not performed does not pass through the encryption device.

4. A computer readable recording medium recording an encryption path switching program executed by a computer of a server in a storage system which comprises: at least a storage device which stores data; at least a server which writes data in and reads out data from the storage device; an encryption device which encrypts data to be written in the storage device by the server and decrypts data to be read out from the storage device by the server; and a switch device which has a plurality of ports to which at least a server, a storage device, and the encryption device are connected, and switches a plurality of paths connecting the plurality of ports according to setting from the outside of the switch device, the program causing the computer to execute:
inputting encryption setting information each of which designates a server resource corresponding to an element of the storage device to be encrypted;
storing the inputted encryption setting information; and
setting connection between the plurality of ports of the switch device on a basis of the stored encryption setting information such that a path on which encryption is performed passes through the encryption device and a path on which encryption is not performed does not pass through the encryption device.
